(19) United States
(12) Patent Application Publication
(10) Pub. No.: US 2004/0036720 A1
(43) Pub. Date: Feb. 26, 2004

(54) Simplified method of printing a digital image

(75) Inventor: Howard K. Dworsky, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/225,761

(22) Filed: Aug. 22, 2002

(51) Int. Cl. G09G 5/00

(52) U.S. Cl. 345/764; 345/810

(57) ABSTRACT

A method for automatically outputting an image by a user, while working in an operating system running on a computer is disclosed comprising the steps of: selecting at least one image provided in a display device that is being driven by the operating system in the computer; selecting an output of the at least one image from a menu that is brought up by the first software program; and automatically outputting the at least one image to the selected output in accordance with the requirements for the selected output without any further user involvement or opening up of any other program by the user.

### FIELD OF THE INVENTION

The present invention relates to simplified printing of digital images on a computer. More particularly, it relates to printing a digital image directly while using the operating system of a computer, without having to launch a separate imaging software application.

### BACKGROUND OF THE INVENTION

When a picture is taken with a conventional film camera the photographer is used to obtaining prints in one of the familiar photofinishing print formats. Examples of standard formats include 4×6 in.(10.16×15.24 cm), also known in the trade as “4R”, 3×5 in.(7.62×12.7 cm), known as 3R, 5×7 in.(12.7×17.8 cm), 8×10 in.(20.32×25.4 cm), and the more recent “C”, “H”, and “P” formats, associated with the Advanced Photo System (APS) standard. Exposed film is simply dropped off at a local processing lab, order preferences are selected, and thereafter no additional work or decisions are required of the photographer in order to obtain high quality prints.

In contrast to this relatively decision-free procedure, now with the introduction of the digital camera, the process of getting a print from a digital image file can become very tedious and difficult. While one of the potential advantages to digital photography is that a photographer can make prints using a personal computer, there is not a consistent and easy way to create prints on a computer in one of the standard formats. Typically, the steps required to create a print are different for every imaging application program and at times may become an impossible task. For example, the steps to create a print in a particular format consist of: (1) finding the picture by browsing the file system; (2) double clicking on the file to open it into an imaging application; (3) resizing and cropping the picture to a standard size as desired using the imaging application software; (4) possibly adjusting the color balance and sharpness enhancement, and finally, (5) printing the image.

Turning first to FIG. 1, there is illustrated a flow diagram of the steps required in a typical prior art method of printing a digital image to a standard 4×6 in. (10.16×15.24 cm) print size using the well known Microsoft Windows 2000™ operating system and an imaging application software program such as Adobe Photoshop™. In step 10, the user first browses his/her image files using, for example, Windows Explorer™. The step of browsing is further illustrated in FIG. 2, a computer screen 15 from Windows Explorer™ where a series of thumbnail images (example, image 20) from the “favorites” directory 25 are displayed for browsing.

Next, in step 30 of FIG. 1, the user selects an image and right clicks on it. Referring to FIG. 3, computer screen 15 is shown where image 35 has now been selected by right clicking and options menu 40 has appeared. Next, in step 45 of FIG. 1 the user selects the “open” option (see menu selection 50 in FIG. 3) and the image opens in the Adobe Photoshop™ image application which had been previously set as the default imaging application for a JPG image. FIG. 4 illustrates a computer screen 55 in Adobe Photoshop™ where an enlarged version of the image 35 (FIG. 3) is shown as opened in Photoshop™. Once the image 35 has been opened, it must be cropped to a 3:2 aspect ratio (step 60 of FIG. 1).

FIG. 4 depicts one such method to crop image 35 using the Adobe Photoshop™ image application. Illustrated in FIG. 4, “Canvas Size” has been previously selected from a pull-down menu (not shown) and the current image width value 65 in pixels and image height value 70 in pixels are displayed in the “Canvas Size” dialog box 75. A new height and width of the image must now be calculated so that the image has the correct aspect ratio.

FIG. 5 shows the new height and width values set in boxes 65 and 70 respectively for image 35 specified so that the image will have the correct aspect ratio of 3:2. Clicking on the “OK” button 80 completes the cropping of the image 35.

After the image has been cropped, the image may also need to be resized to produce a 4R size (4″×6″) print (step 85 of FIG. 1). Still working in the Adobe Photoshop™ program, as illustrated in FIG. 6, the current height value 90 and width value 95 of the image 35 in inches is now displayed in the “Image Size” dialog box 100. In FIG. 7, the height and width values are shown reset now to 4 and 6 inches respectively as indicated in boxes 90 and 95 respectively. Again, clicking on “OK” button 105 completes the resizing of image A. The image is now ready to print (step 110 of FIG. 1).

As depicted in FIG. 8, the Windows™ “File” pull-down menu has first been activated and print menu option 115 is selected, causing the print options dialog box 120 to open (see FIG. 9). Once printing options have been selected (step 130 of FIG. 1) “OK” button 135 in FIG. 9 is clicked and the image is then printed by the printer designated as the default printer.

It is known to print a data file directly from the Windows™ operating system without opening the document in any application program, for example, a word processing program, by right clicking on the document in a folder and selecting “print” from the menu which appears. Published European patent application EP 1 096 363 A2 to Ogino discloses a method of extending the print capability for a document directly from the operating system to include automatic selection from a plurality of printing pathways. The Pic-A-View™ software application, available from ACD Systems, Inc, enables printing of an image file directly by right clicking on an image file. However, the user of the Pic-A-View™ software must still adjust the image size, aspect ratio and desired print resolution using a series of dialog boxes. Thus there remains unsolved in any of these solutions the problem of automatically adjusting aspect ratio and image size of a data file to produce a print of a target size with no further involvement of the user once an image has been selected for printing.

Another problem with printing images is that the printing process can be wasteful of expensive materials because when only one or a small number of prints is needed, a significant portion of the print media may not be efficiently utilized. The normal print media page size for most common printing systems is 8½×11 inches so that, for example, if just a few prints are needed, there may be a complex layout decision to be made to maximize the use of the available media area with minimum waste.

Still another problem encountered with printing is that when it is desired on purpose to print more than one image on the same page, as for example in the creation of a photo album leaf, the problem is multiplied. Not only must several different images be separately resized and cropped; but complex decisions regarding optimum layout of the images must be made.

A similar problem exists for emailing images. Since many image files are large in size, it is inefficient to email the complete file, and the image should be resized before sending it. The sequence of steps required to resize an image is similar to that illustrated above for printing an image and is, therefore, quite complex for the average computer user. The prior art has provided one solution to at least part of the problem of attaching image files to email. The use of an email software program can be bypassed if all of the images are stored on a central server and a URL for viewing the images is sent to the recipients. Because many viruses are sent as email attachments, this implementation could also help in not spreading a virus or avoiding a virus; by storing the images on a central server, attachments are not necessary. Again, however, the number and complexity of the steps required to properly store images on a central server and send a URL to a recipient makes this approach difficult for the average user.

Thus there is a need for a method whereby a photographer can easily and conveniently obtain prints or album pages, send email from digital image files directly, or post images to a server, where the selection of the appropriate imaging application or emailing application is avoided and the steps of cropping, resizing, and printing the picture are carried out automatically and the number of decisions required is reduced to a minimum.

### SUMMARY OF THE INVENTION

In answer to these problems of the prior art, in one aspect of the present invention there is provided a method for automatically outputting an image by a user, while working in an operating system running on a computer, comprising the steps of: selecting at least one image provided in a display device that is being driven by the operating system in the computer; selecting an output of the at least one image from a menu that is brought up by the first software program; and

automatically outputting the at least one image to the selected output in accordance with the requirements for the selected output without any further user involvement or opening up of any other program by the user.

In accordance with another aspect of the present invention, there is provided a computer software program such that when placed on a computer as part of an operating system for the computer, the program would cause a computer to perform the steps of: allows the selection of at least one image provided on a display device that is being driven by the computer; allows the activation of an input device so as to provide a selection menu on the display device whereby a user can select an output type by one of the menu selections, without the user having to take any further action or open any other software program.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a flow chart detailing the steps required in a prior art method of printing;

FIG. 2 shows a computer display screen showing the selection of an image in accord with either the prior art or the present invention;

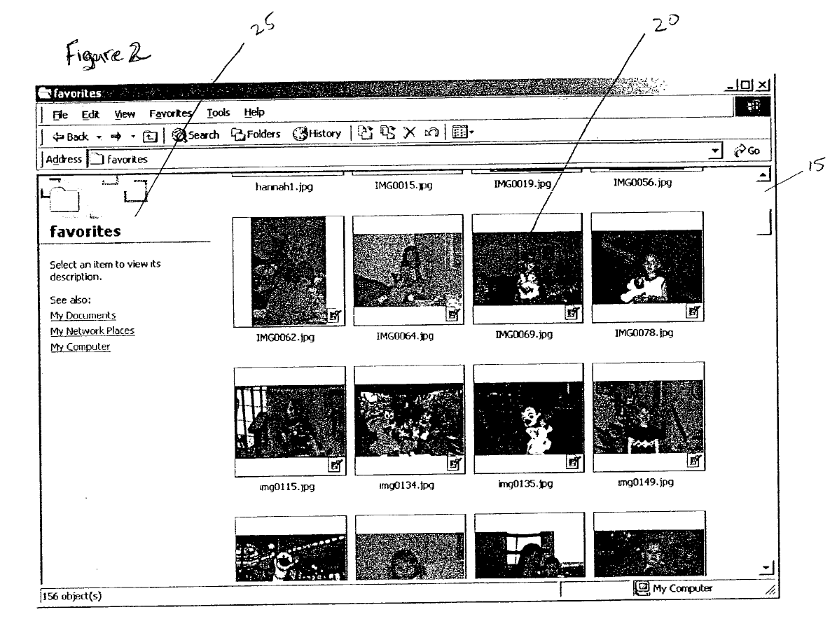

FIG. 3 shows a prior art computer display screen showing the selection of a printing option of a digital image

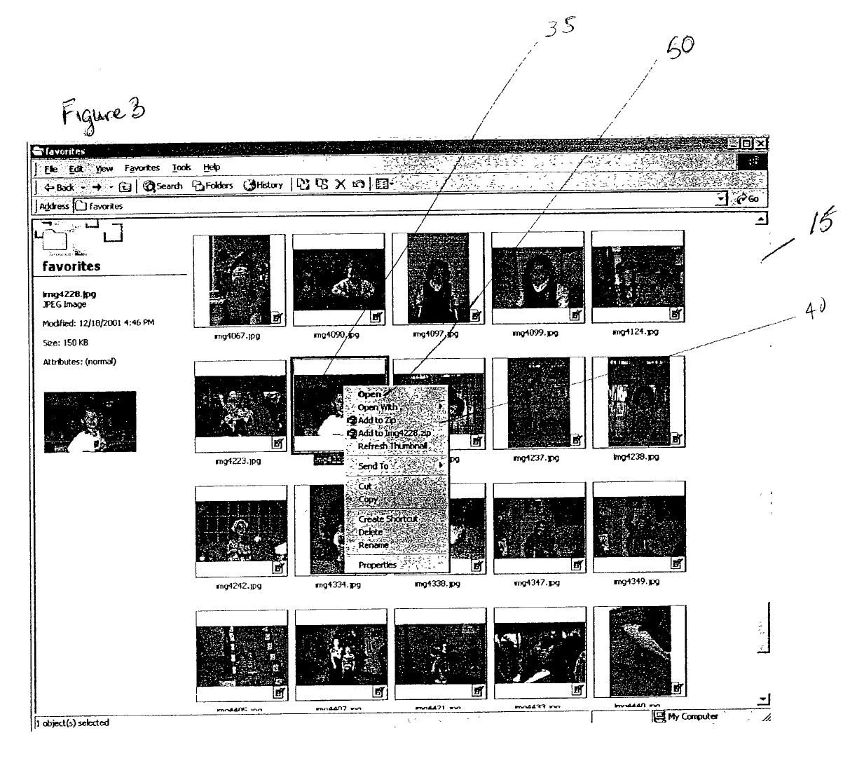

FIG. 4 shows a prior art computer display screen for adjusting the aspect ratio of an image to be printed;

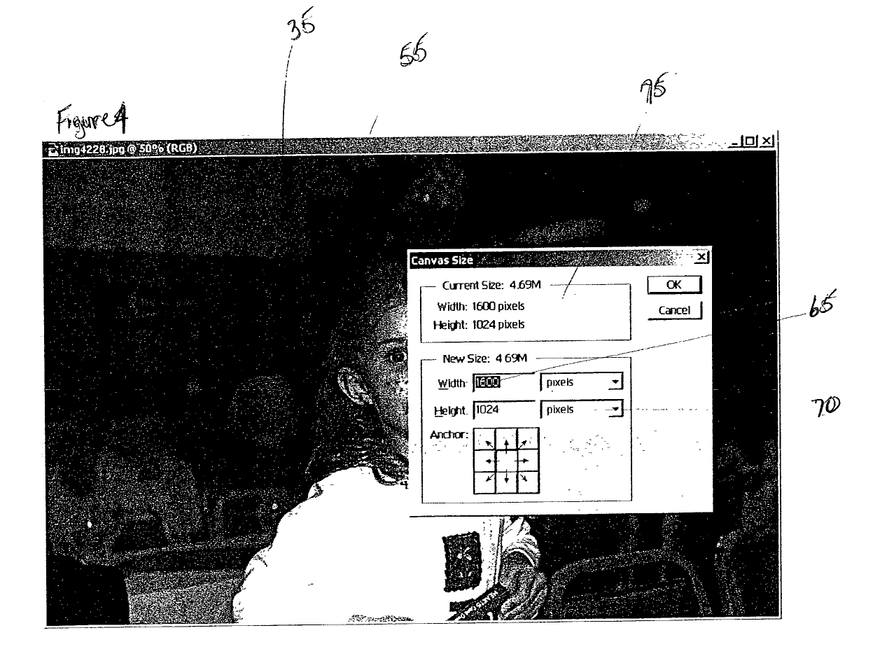

FIG. 5 shows a prior art computer display screen where the aspect ratio of an image to be printed has been selected;

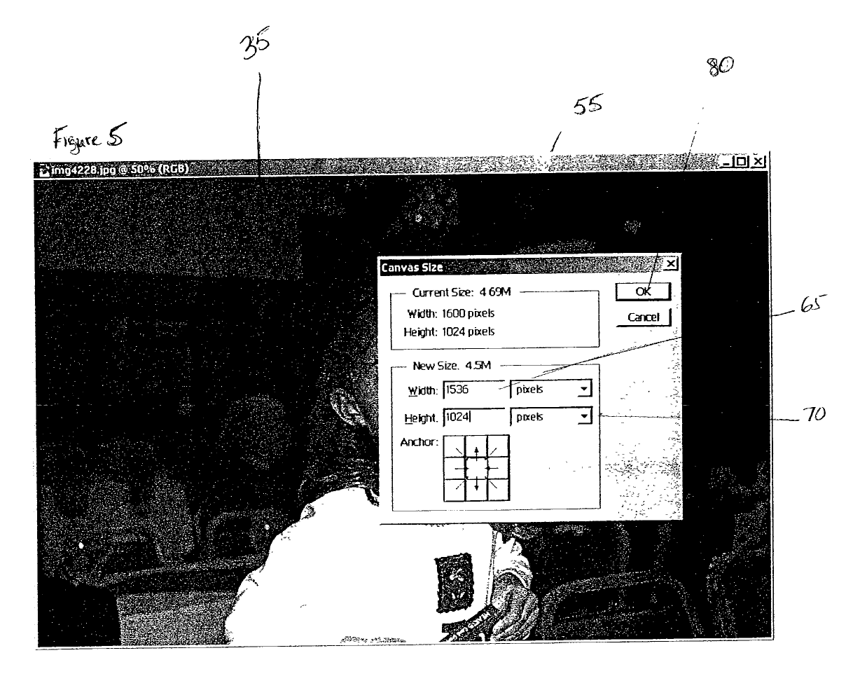

FIG. 6 shows a prior art computer display screen for adjusting the size of an image to be printed;

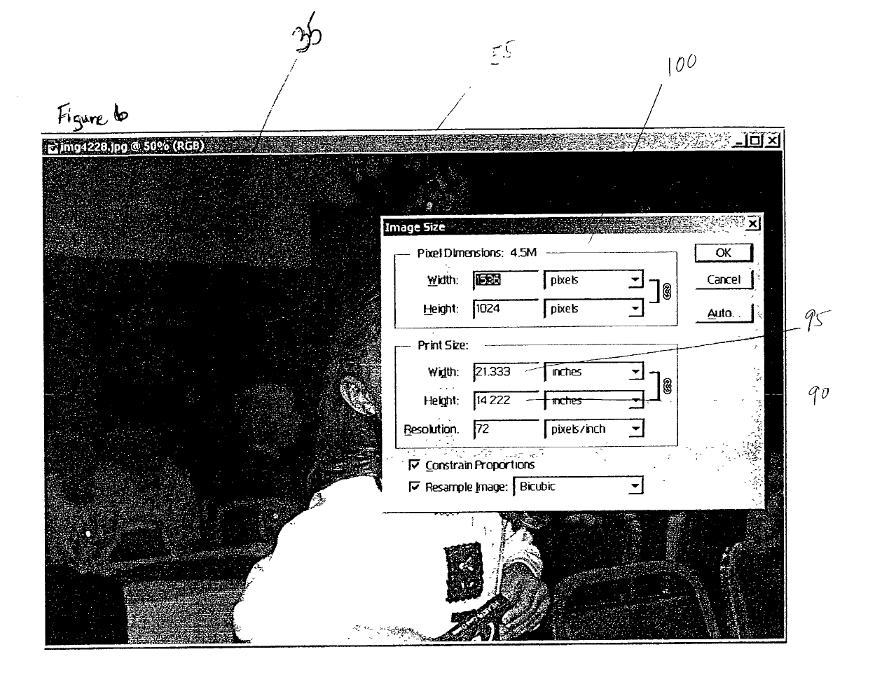

FIG. 7 shows a prior art computer display screen where the size of an image to be printed has been selected;

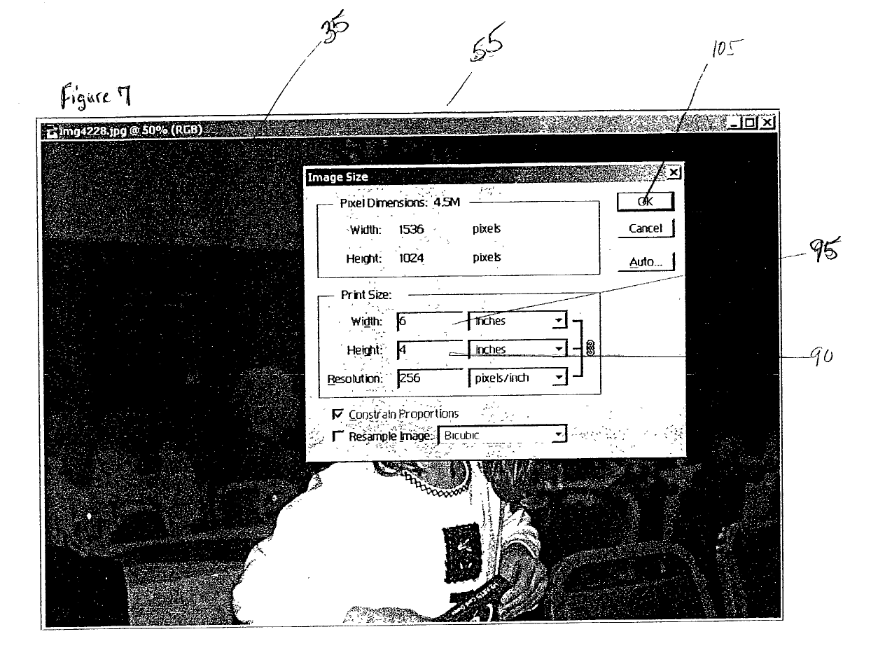

FIG. 8 shows a prior art computer display screen displaying a menu for selecting a print option for printing an image;

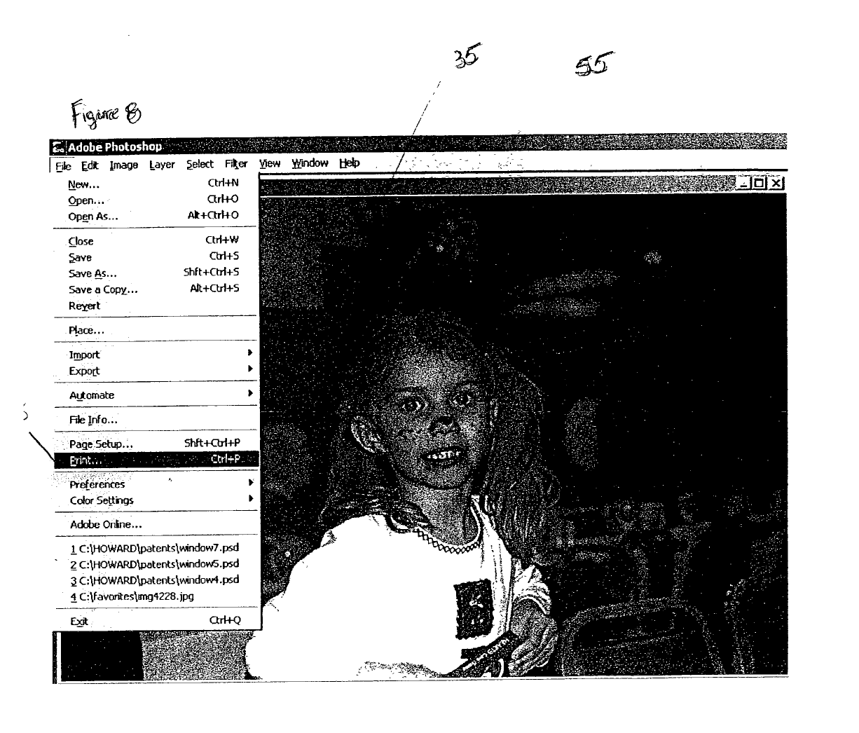

FIG. 9 shows a prior art computer display screen where parameter options for printing a digital image are selected;

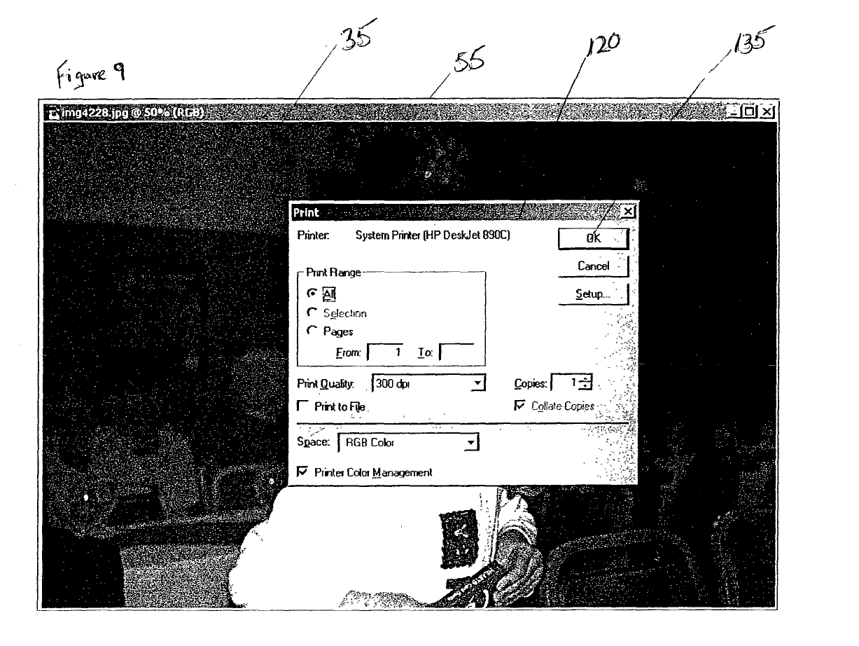

FIG. 10 shows a flow chart describing the overall steps to be carried out in the practice of the present invention;

FIG. 11 shows computer display screen in accordance with the present invention where output options for designated images may be selected;

FIG. 12 shows computer display screen in accordance with the present invention where hard copy print options for designated images may be selected;

FIG. 13 shows a flow chart detailing the steps carried out by a computer program for printing an image activated in the operation of the present invention;

FIG. 14 shows computer display screen in accordance with the present invention where emailing options for a designated image may be selected; and

FIG. 15 shows a flow chart detailing the steps carried out by a computer program for emailing an image activated in the operation of the present invention.

### DETAILED DESCRIPTION OF THE INVENTION

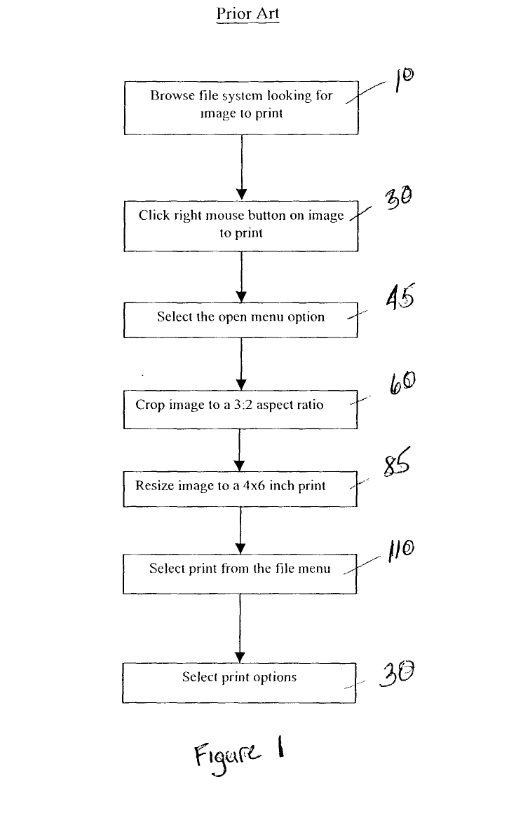

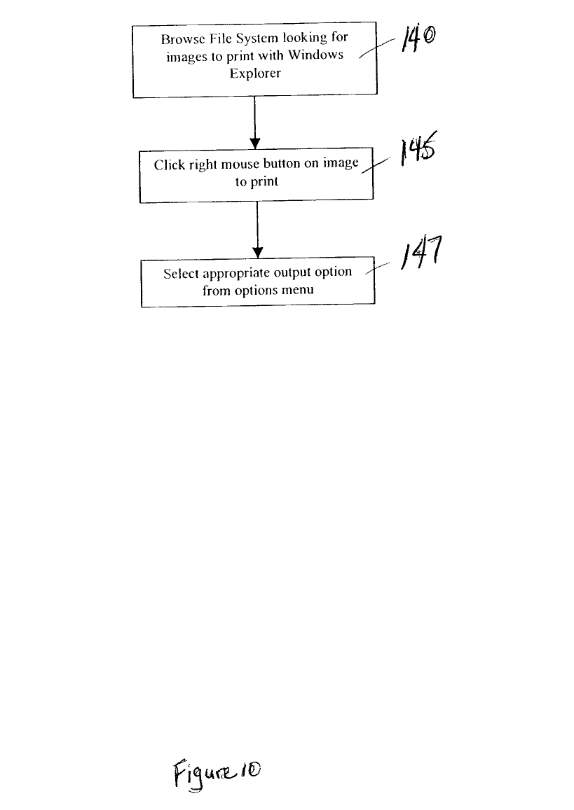

Turning now to a description of the operation of the present invention, FIG. 10 shows a flow chart of the steps which are needed to print an image by the inventive method disclosed. Steps 140 and 145 are identical to steps 10 and 30 respectively of FIG. 1 where the user first browses for an image file and then right clicks on the image for printing. Once an image has been right clicked, then in step 147, the user then selects an appropriate output option. The operation of the various output options enabled by the invention will now be described.

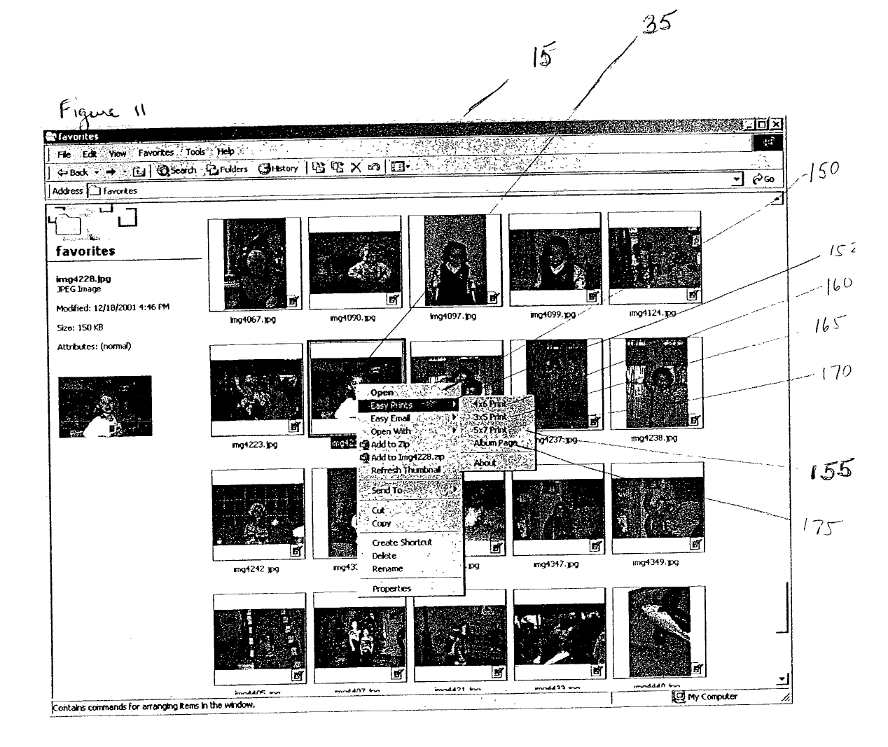

In FIG. 11 is shown display screen 15 where image 35 has been selected. It will be understood that any of a number of means for selecting images in a browser display may be employed with the present invention including, for example, using a mouse input device, or selecting images using keyboard commands, or using any one of a number of voice activated interfaces known in the art. When the user right clicks on image 35 the new options menu 150 appears with selection “Easy Prints” 152 along with various sub-menu 155 options “4×6 Print” 160, “3×5 Print” 165, “5×7 Print” 170 and “Album Page” 175.

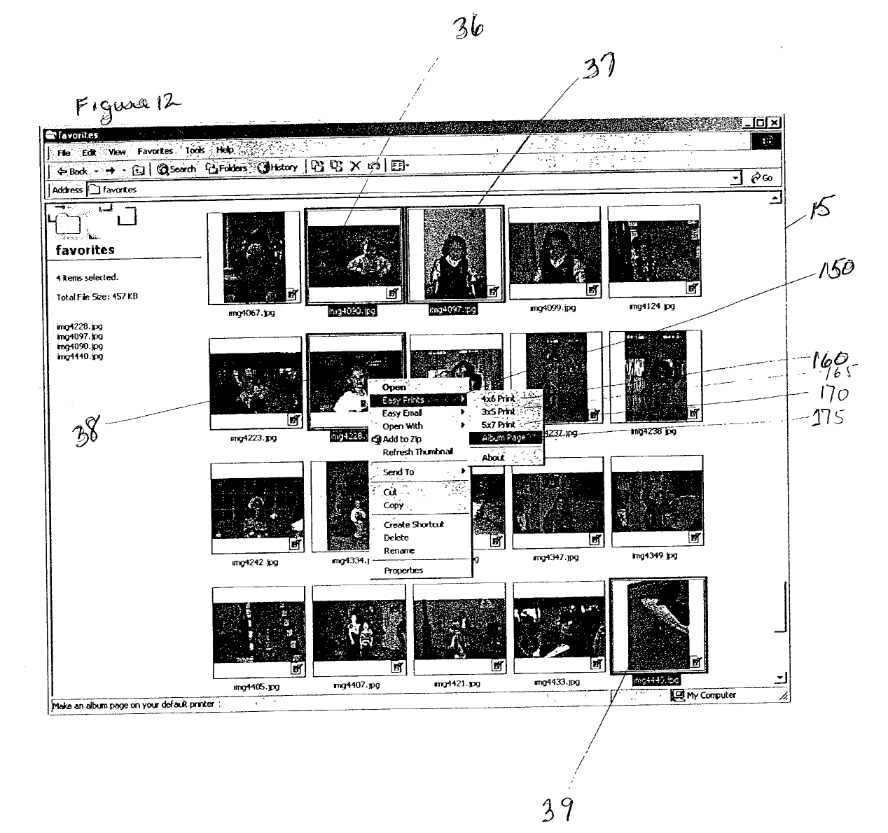

Options menu 150 was created in accordance with the present invention using the capability of the Microsoft Windows™ operating system which provides an interface where a software developer can extend the functionality of the Windows shell. Once extended functionality is created, the Windows™ operating system automatically executes code whenever a user uses the right mouse button to click on a previously selected file or multiple files (see FIG. 12 where multiple images 36, 37, 38, and 39 have all been selected) having a specific file extension. In the present invention, when the user right clicks on a previously selected image file having the JPG file extension customized menu 150 is caused to appear and the user then has the ability to select the appropriate menu option.

It should be appreciated that while the present embodiment is illustrated for image files in the JPEG format the invention may be enabled to operate with any image format.

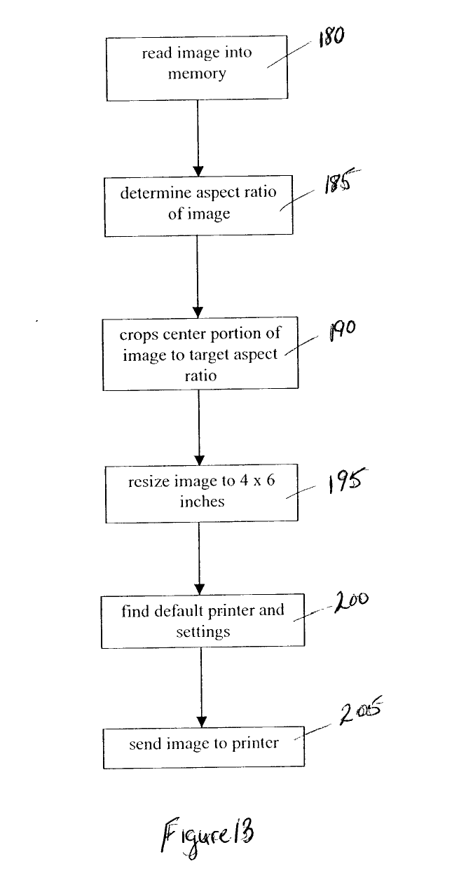

Continuing with the example shown in FIG. 12, when the user selects a print option such as the 4×6 print option 160, the Windows™ operating system automatically executes the appropriate program to produce the print. The program as provided by the present invention performs the following steps as listed in FIG. 13. First the program reads the image into computer memory (step 180). Next, in step 185, the aspect ratio of the image is automatically determined from the pixel width and height of the image. Then in step 190, if needed, the program crops the center portion of the image to an aspect ratio of 3:2. In step 195, the image is resized to the target 4×6 in print size. Next, the program interrogates the computer in step 200 to find the default printer, paper size and type (for example, photo quality paper) and resolution and, finally, in step 205, sends the image to the printer to be printed.

Once the default resolution is known, the image is printed to the size that will produce the appropriate sized print on the default printer. Since most users only have one printer attached to their computer it is ordinarily not necessary to go through the a separate step or steps to select a printer. The only requirement of the printer is that it be supported by the Microsoft Windows 2000™ software. Ink jet, thermal, or electrophotographic printers would all operate with the invention. Depending upon which type of printer is used, it may be desirable for the user to have inserted a special print paper or other print media appropriate for the printing of photographs.

It will be understood that while the particular embodiment of the invention disclosed here is for the Windows 2000™ operating system, the invention can be made to operate with any version of the Windows™ operating system, version 95 and higher. It should also be appreciated that while the embodiment illustrated discloses the use of a local printer, the program could easily be extended to support sending the print to a remote printing facility, for example over a communications channel such as the Internet.

In the case such as that shown in FIG. 12 where multiple image files 36,37,38, and 39 have been selected, several printing options are possible with the present invention. If any of print size options 160, 165, or 170 have been selected, then, based on the size of the paper in the printer, the program fits as many images as possible on the page in order to conserve paper.

When the album page option 175 is selected, the program automatically optimizes the location of each image to generate a visually pleasing result. A method of automatically laying out and optimizing an album page from a selection of designated images particularly useful for the practice of the present invention has been previously disclosed in the commonly assigned, co-pending U.S. patent application Ser. No. 09/825,453 by Simon et al., and is hereby incorporated by reference in its entirety. Once the album page option 175 has been selected, then, as disclosed by Simon, an algorithm automatically selects a trial layout which is displayed to the user. The user then has the option to either try another layout, and continue trying layouts until a pleasing one is found, or start over and select different images for a page. Once a pleasing page has been found, the user activates a “print” option and the page is automatically printed.

Another commonly performed task with images is emailing a digital image to a recipient as an attachment. The prior art methods of accomplishing this task are again quite complex. First, an image must first be properly sized for email; emailing an image which is too large (has more data than is required for screen display) may require a very long time for up and downloading to and from the email server, especially where only a relatively low bandwidth connection to the Internet is available. Once the image has been resized, it must be renamed and saved to a location. Then an email application is opened, addressed with the email address(es) of the recipient(s) and an attachment of the resized image is created. Finally, the email is sent.

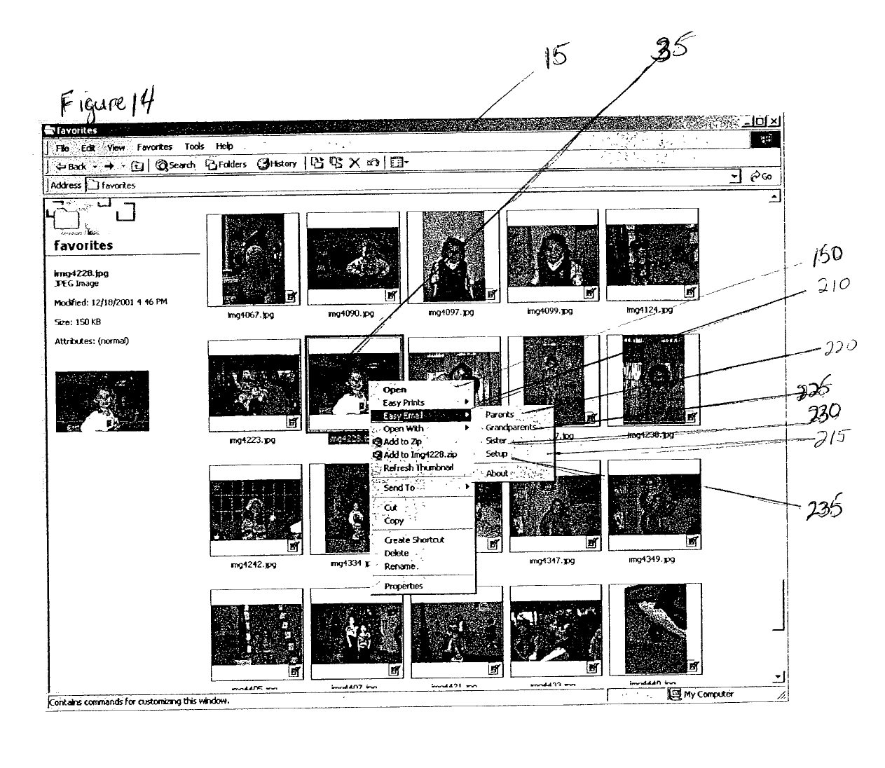

Another embodiment of the present invention which is useful to simplify this task of attaching and then sending an image by email to a recipient will now be described. Turning to FIG. 14, display screen 15 is shown where image 35 has been selected by right clicking on it. Upon selection of the image 35, options menu 150 appears and to email the image, the user selects the “Easy Email” selection 210. Selection of the Easy Email selection 210 causes sub-menu 215 to appear with options “Parents” 220, “Grandparents” 225, “Sister” 230 and “Setup” 235 available. It should be appreciated that the options illustrated on submenu 215 are by way of example only, and that many other types of menu options could be displayed such as the actual names or nicknames of potential recipients, or generic distribution lists such as, for example, “friends” or “fishing buddies” or the like. While not illustrated, it will also be understood that the user has previously selected the setup menu option 235 to enter the email recipients' names and email addresses, set up distribution lists, enter any other required email parameters, select a default image resolution suitable for email, or specify a web server for image storage or even remote printing, such as by a service provider, for example the Ofoto™ on-line printing service.

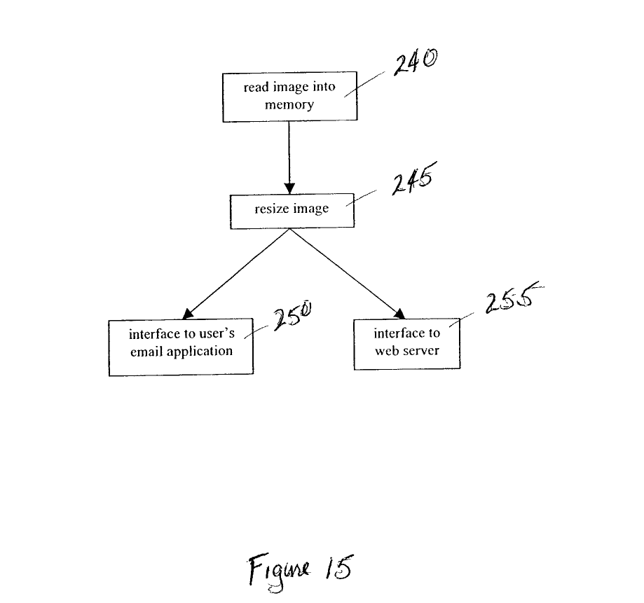

Returning to the example, when the user selects a particular email recipient option from menu 215, such as the “parents” option 220, the Windows™ operating system automatically executes the appropriate program to send the email. The program as provided by the present invention performs the following steps as shown in FIG. 15. First the program reads the image into computer memory (step 240). Next, in step 245, the image is scaled to the resolution appropriate for emailing which had been selected in the setup phase. If the image is to be sent as a mail attachment (step 250) the program then interfaces to the user's email application to mail the image. If the image is to be sent to a web server, the program interfaces to the web server to store the image and send an email with a URL to view the image (step 255).

If more than one image is selected for emailing, the program automatically creates multiple attachments to the designated email file, corresponding to the multiple images selected. If multiple images are selected for posting to a web server, the images may be laid out on a web page using the layout algorithm disclosed by Simon in the '453 application discussed previously for the printing of album pages.

It is to be understood that various modifications and changes may be made without departing from the present invention, the present invention being defined by the following claims.

### Parts List

10 step

15 computer display screen

20 image

25 directory

30 step

35 image

36 image

37 image

38 image

39 image

40 options menu

45 step

50 menu selection

55 computer display screen

60 step

65 width value in pixels

70 height value in pixels

75 dialog box

80 “OK” button

85 step

90 height value in inches

95 width value in inches

100 dialog box

105 “OK” button

110 step

115 print menu option

120 dialog box

130 step

135 “OK” button

140 step

145 step

147 step

150 options menu

152 menu selection item

155 sub menu

160 sub menu option

165 sub menu option

170 sub menu option

175 sub menu option

180 step

185 step

190 step

195 step

200 step

205 step

210 menu selection item

215 sub menu

220 sub menu option

225 sub menu option

230 sub menu option

235 sub menu option

240 step

245 step

250 step

255 step

What is claimed is:

1. A method for automatically outputting an image by a user, while working in an operating system running on a computer, comprising the steps of:
selecting at least one image provided in a display device that is being driven by said operating system in said computer;
selecting an output of said at least one image from a menu that is brought up by said first software program; and
automatically outputting said at least one image to said selected output in accordance with the requirements for said selected output without any further user involvement or opening up of any other program by said user.

2. The method according to claim 1 wherein said step of selecting an output further comprises selecting a desired hard copy print size.

3. The method according to claim 2 wherein said step of automatically outputting said selected output further comprises minimizing hard copy print media waste by automatically optimizing a layout of said at least one selected images.

4. The method according to claim 1 wherein said step of selecting an output further comprises selecting at least one album page wherein a layout of said at least one image on said album page is created automatically.

5. The method according to claim 1 wherein said step of selecting an output further comprises selecting at least one email address for output of said at least one image as an email attachment.

6. The method according to claim 1 wherein said step of selecting an output further comprises selecting at least one web address for output of said at least one image to a web page corresponding to said at least one web address.

7. A computer software program such that when placed on a computer as part of an operating system for said computer, said program would cause a computer to perform the steps of:
allows the selection of at least one image provided on a display device that is being driven by said computer;
allows the activation of an input device so as to provide a selection menu on said display device whereby a user can select an output type by one of said menu selections, without said user having to take any further action or open any other software program.

8. A computer software program according to claim 7 further comprising the steps of:
reading said at least one selected image into memory;
determining an aspect ratio for said at least one selected image and cropping the center of said at least one image to a target aspect ratio;
resizing said at least one image to a target size;
finding a default printer connected to said computer and default settings for said printer; and
sending said at least one image to said printer for printing.

9. A computer software program according to claim 7 further comprising the steps of:
allows selection of an album page option from said selection menu;
reading said at least one selected image into memory;
resizing said at least one image to a target size;
automatically laying out said at least one images on at least one said album page;
finding a default printer connected to said computer and default settings for said printer; and
sending said at least one album page to said printer for printing.

10. A computer software program according to claim 7 further comprising the steps of:
reading said at least one selected image into memory;
resizing said at least one image to a size optimized for email;
allowing selection of at least one email address; and
automatically creating email attachments for said at least one selected images.

11. A computer software program according to claim 7 further comprising the steps of:
reading said at least one selected image into memory;
resizing said at least one image to a size optimized for web publishing;
allowing selection of at least one URL; and
sending said at least one image to said URL for publishing.

12. A computer program according to claim 1 further comprising the step of:
automatically laying out said at least one image on at least one web page for said web publishing.

13. A computer software program according to claim 7 wherein a second selection menu is provided for providing further detailed options for selecting an output type by said user.

14. A computer software program according to claim 7 wherein said input selection device comprises a mouse click or a keystroke.

15. A computer software program according to claim 7 wherein said input selection device comprises a voice activation program.
